(19) United States
(12) Patent Application Publication
(10) Pub. No.: US 2025/0053713 A1
(43) Pub. Date: Feb. 13, 2025

(54) Design of Fiber Reinforced Polymer Building Systems

(71) Applicant: NORTHSTAR TECHNOLOGIES GROUP INC., BONITA SPRINGS, FL (US)

(72) Inventor: Paul A. Inglese, Naples, FL (US)

(73) Assignee: NORTHSTAR TECHNOLOGIES GROUP INC., BONITA SPRINGS, FL (US)

(21) Appl. No.: 18/797,936

(22) Filed: Aug. 8, 2024

Related U.S. Application Data
(60) Provisional application No. 63/531,535, filed on Aug. 8, 2023.

(51) Int. Cl. G06F 30/27; G06F 30/13; G06F 111/04; G06F 113/26; G06F 119/18

(52) U.S. Cl. CPC G06F 30/27; G06F 30/13; G06F 2111/04; G06F 2113/26; G06F 2119/18

(57) ABSTRACT

A method comprises configuring machine learning to generate an architectural model; configuring machine learning to adapt the architectural model to satisfy structural design constraints and optimize at least one objective function; configuring machine learning to select structural components for use in the architectural model; and configuring a machine for manufacturing or assembling the structural components. The architectural model can comprise fiber reinforced polymer (FRP) elements that are selected based on their performance characteristics in order to satisfy the structural design constraints and optimize the at least one objective function.

### CROSS REFERENCE TO RELATED APPLICATIONS

This Application claims the priority benefit of U.S. Provisional Application No. 63/531,535, filed on Aug. 8, 2023, which is expressly incorporated by reference herein in its entirety.

U.S. Pat. Appl. Ser. No. 63/526, 168, filed on Jul. 11, 2023; U.S. patent application Ser. No. 18/126,987, filed on Mar. 27, 2023; U.S. patent application Ser. No. 17/093,262, filed on Nov. 9, 2020; U.S. patent application Ser. No. 18/207,438, filed on Jun. 8, 2023; U.S. patent application Ser. No. 17/411,041, filed on Aug. 24, 2021; and PCT Appl. Ser. No. PCT/US21/47414, filed on Aug. 24, 2021 are each expressly incorporated by reference herein in its entirety.

### INTRODUCTION

### I. Field

Aspects of the disclosure relate to computer aided design systems, and more specifically, computer aided design systems, computer aided design applications, and associated programming interfaces and scripting languages operable with machine learning configured to design building systems and structural components comprising Fiber Reinforced Polymer (FRP).

### II. Background

The background description includes information that may be useful in understanding the present inventive subject matter. It is not an admission that any of the information provided herein is prior art or relevant to the presently claimed subject matter, or that any publication, specifically or implicitly referenced, is prior art. All publications disclosed herein are incorporated by reference in their entireties. Without limiting the scope of this disclosure as expressed by the claims which follow, some features will now be discussed briefly.

Computer aided design (CAD) relies on the processors and memory circuits (both working memory and storage memory) of computers, sometimes called computer workstations. CAD permits users to create, analyze, modify, and optimize mechanical and physical designs before implementing the designs.

In a typical design process for a building, an architect generates an architectural plan that specifies an outline for the building, one or more outlines for each floor, and any number of architectural elements that are going to be included in the building. Once the architectural plan is completed, a structural engineer designs the structural system for the building based on the plan, various design constraints on the building, various design objectives, and various design variables. The structural system includes any number of structural members that, together, enable the building to resist various loads as per the design constraints. In one approach to designing the structural system, the engineer might employ a CAD to generate possible models, where each model satisfies the various design constraints placed on the building. Design constraints can mean structural design constraints, which might be embodied by various structural compliance criteria. Examples of structural compliance criteria might include building standards, architectural standards, certifications, and/or ratings.

Artificial neural networks (ANNs) are comprised of multiple hidden layers, and each of the hidden layers has multiple hidden nodes which consist of an affine map of the outputs from the previous layer and a nonlinear map called an activation function. The nonlinear activation function makes neural networks differ from the linear models, that is, a neural network becomes a linear function if a linear activation function is used. The problem of training a feedforward neural network is to determine a number of adjustable parameters or connection weights based on a set of training data. A trained feedforward neural network can be regarded as a nonlinear mapping from the input space to the output space.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Disclosed aspects can be generalized to any of various ML models, such as (but not limited to) logistic regression (LR), support vector machines (SVM), decision trees (DT), and nearest neighbor (kNN). Other ML models might be employed.

The aspects disclosed herein can be adapted to methods, individual processors, systems of processing elements, computer software residing on non-transitory computer-readable memory that is programmed to perform disclosed methods, and/or electronic circuitry, for example.

There is a need in the construction industry that can be served by provisioning building components and assemblies that are manufactured with advanced composite technologies that have dramatically improved strength-to-weight ratios. Fiber-reinforced polymer (FRP) components can be manufactured to have a wide range of mechanical and physical properties, and assemblies of such components can be configured to achieve advantageous performance characteristics compared to other materials and designs. Some disclosed aspects configure machine learning (ML) for learning the complex relationships between the myriad design variables and the multitude of possible features and characteristics, and exploiting knowledge of these relationships to tune a structural design to optimize an objective function while satisfying design and performance constraints. Such ML modeling can be implemented with an artificial neural network (ANN) that interfaces with an architectural CAD system.

Some aspects of the disclosure provide a system that uses machine learning and data-mining techniques applied to the field of architectural design and modular building, and relates to CAD tools in order to dramatically reduce design time for new designs.

While component objects may be created and analyzed individually, it can be advantageous for CAD systems to combine the component objects to form subassemblies and assemblies (e.g., building modules) to obtain the full benefit of using a CAD system. Therefore, the CAD system might be configured to model subassemblies and account for interactions between components of the subassemblies, including connectors, fasteners, epoxy, and the like. Furthermore, the CAD system might be configured to model assemblies and account for interactions between their constituent subassemblies. In any of the disclosed aspects, a flexible epoxy might be used to bond elements together that are described herein as being joined, connected, bonded, or adhered, the flexible epoxy being provisioned to provide a uniform coefficient of thermal expansion throughout the subassemblies, assemblies, and/or entire building system.

As described herein, a structural design application can define an overall optimization design problem, and then break down the overall optimization design problem into multiple layers of more granular, less complex, optimization problems, referred to herein as constituent optimization problems. Each of the constituent optimization problems might be associated with a different aspect of structural system design problem. To solve the overall optimization design problem, the structural design application can execute a macro-design flow that dynamically self-adjusts based on results generating while solving the constituent optimization problems.

In some aspects of the disclosure, a client-server or client-cloud CAD system can have large numbers of clients accessing software or running native applications that can collaborate in processing and/or data sharing. Cloud systems and other distributed systems can gather information from users and provision methods for brokering vast amounts of collected data among the users, as well as performing computationally intensive tasks via remote servers, an ANN can configure server/cloud-hosted databases and data-stores for learning and model generation, and can include a feedback path to client CAD applications for providing predictions and design proposals to the user to achieve predetermined goals.

Some aspects of the disclosure provide for apparatus, system, methods of performing, and methods of providing for (including computer-implanted methods) architectural structure analysis, comprising accessing a computer-implemented design model representing an architectural structure; and determining fiber reinforced polymer (FRP) design parameters for at least one of a plurality of FRP components in the model; wherein the design parameters are determined from structural compliance criteria for the architectural structure.

Some aspects of the disclosure involve a method or system for configuring machine learning to generate an architectural model; configuring machine learning to adapt the architectural model to satisfy structural design constraints and optimize at least one objective function; configuring machine learning to select structural components for use in the architectural model; and configuring a machine for manufacturing or assembling the structural components.

In some aspects, an architectural plan machine-learning system can be configured to generate an architectural model; a structural design machine-learning system communicatively coupled to the architectural plan machine-learning system can be configured to adapt the architectural model to satisfy structural design constraints and optimize at least one objective function; and a CAD system (which is communicatively coupled to at least one of the structural design machine-learning system and the architectural plan machine-learning system) can be configured to provide an interactive display of manufacturing or construction plans for enabling a user to add, delete, and/or modify structural components in the manufacturing or construction plans.

The focus of some disclosed aspects is on specific improvements in computer capabilities, particularly improvements to computer functionality itself. Disclosed methods, non-transitory computer-readable memory with instructions to configure a processor to function in a prescribed manner, and processor-plus-memory configurations provide for improving the operation of the computer processor itself, such as might be accomplished by tuning an ANN to produce a design more quickly. Furthermore, some disclosed aspects might comprise non-conventional and non-generic arrangements of known, conventional parts.

In one aspect, a method for operating a software agent (e.g., an ANN configuring according to disclosed aspects) in a distributed environment generally comprises collecting information from the environment; storing the information in a knowledge base; employing reasoning mechanisms to process the information and make decisions; executing actions in the environment based on the decisions; communicating with other agents or external entities to exchange information, coordinate activities, collaborate, or negotiate; monitoring the software agent's own and/or other agents' actions; setting goals and planning actions to achieve the goals; and learning and adapting by updating the knowledge base.

The information comprises measurements of physical phenomena. Such physical measurements might include stress, deflection, or deformation of a component or building module under test. Executing actions in the environment can comprise controlling how a machine operates, such as causing a change in cutting, manufacturing, or assembly. Furthermore, learning is a means by which an ANN tunes the way a processor configured to perform the ANN's instructions operates. This constitutes a change in the operation of a physical device (e.g., a computer processor), resulting in an improvement of its efficiency, which is also a measurably quantifiable property. For example, the efficiency of how a computer processor performs its operations directly affects how much power the processor uses, and/or might directly result in the amount of hardware required to perform a given task within a given time constraint. Thus, disclosed ANN aspects improve the design process for FRP components, modules, subassemblies, assemblies, and/or building structures in a measurably quantifiable way as it pertains to the operation of computers and/or computer networks.

When multiple devices coordinate activities, collaborate, or negotiate in a joint processing operation between the devices, it constitutes tuning the system of devices to improve the system's operation. As such, the improved operation of the system can be quantified as a measurement in the time it takes to perform a given task, the amount of energy consumed to perform the task, the amount of hardware required to perform the task, and/or the amount of physical-layer resources needed to communicate coordinate, collaborate, or negotiate.

Learning and adapting both constitute tuning a physical device or system to improve its function. Tuning the device or system improves efficiency of its operation, such as requiring fewer computations, fewer processing cycles, fewer function calls, fewer memory accesses, etc. The effects of tuning can be quantified using measurable operating parameters of a computer system, such as the speed that a computer system performs a particular operation. Since the knowledge base is used to execute actions, updating the knowledge base in a manner that affects the execution of actions constitutes tuning. Furthermore, updating data structures disclosed herein can improve the way a computer processor stores and retrieves data in memory, communicates with other processors, routes data through a network, and/or improves the function of processing devices by preventing or reducing operations that detract from their performance.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a schematic representation of an environment in which a client device may utilize an application programming interface (API) to interface with a server hosting a CAD application according to some aspects of the disclosure.

FIG. 2 is a block diagram illustrating an example of a hardware implementation of a client device employing a processing system according to some aspects of the disclosure.

FIG. 3 is a flow diagram that illustrates a method according to one aspect of the disclosure.

FIG. 4 is a flow diagram depicting a method according to an alternative aspect of the disclosure.

FIG. 5 shows an example of method and apparatus aspects configured to design and manufacture physical structures.

FIG. 6 illustrates disclosed aspects that can be embodied by various systems, devices, methods, and servers.

FIG. 7 is a machine-learning flow diagram that can be implemented in disclosed method, apparatus, and system aspects.

FIG. 8 is a machine-learning flow diagram that can be implemented in disclosed method, apparatus, and system aspects.

FIG. 9 is a machine-learning flow diagram that can be implemented in disclosed method, apparatus, and system aspects.

FIG. 10 is a schematic representation of a computer processing environment in which CAD and machine-learning systems and methods may be configured according to some aspects of the disclosure.

FIGS. 11, 12A, and 12B depict various workflows according to disclosed aspects. These workflows can be embodied as apparatus, system, and/or method implementations. This includes methods for performing the workflows, methods for configuring systems and/or devices to perform the workflows, computer-implemented methods of performing the workflows, and instructions on non-transitory computer-readable memory that, when executed by one or more processors, cause the one or more processors to perform any of the workflows. Disclosed aspects can comprise any of the disclosed elements individually as separate devices, components, or methods (for example).

### DETAILED DESCRIPTION

The description that follows includes exemplary systems, methods, techniques, instruction sequences, and computer program products that embody techniques of this disclosure. However, it is understood that the described aspects may be practiced without these specific details.

Apparatuses and methods are described in the following description and illustrated in the accompanying drawings by various blocks, modules, components, circuits, steps, processes, algorithms, etc. (collectively referred to as “elements”). These elements may be implemented using electronic hardware, computer software, firmware, or any combination thereof.

Aspects disclosed herein can be configured to operate with various types of artificial neural networks, including (but not limited to) feed forward, multilayer perceptron, deep feed forward, radial basis, convolutional neural networks, recurrent, gated recurrent, long/short term memory, auto encoder, variational auto encoder, denoising auto encoder, sparse, nested, Markov chain, Hopfield, Boltzman machine, restricted Boltzman machine, deep belief, deep convolutional, deep convolutional inverse graphics, deconvolutional, generative adversarial, liquid state machine, extreme learning machine, echo state, deep residual, Kohoren, support vector machine, Neural Turing Machine, sequence-to-sequence, modular neural networks, and combinations thereof.

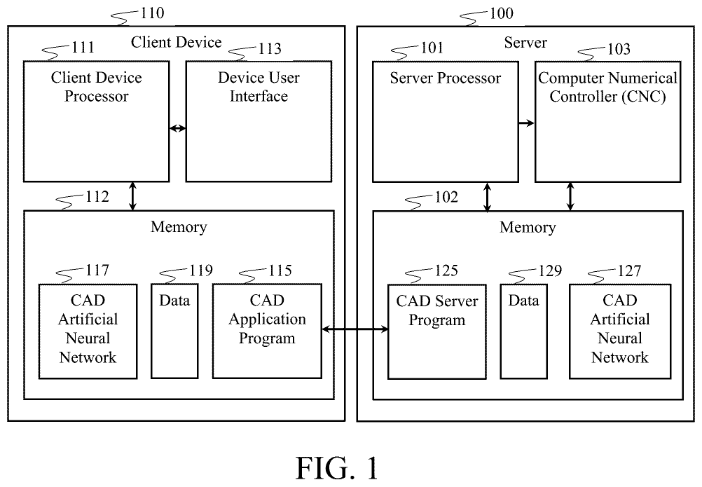

FIG. 1 illustrates a computing system environment that can be configured in accordance with aspects disclosed herein. A server 100 is communicatively coupled to one or more clients (e.g., client device 110) via at least one communication network. The server 100 comprises at least one processor 101, memory 102, and at least one controller 103 for an FRP manufacturing apparatus (not shown). The client device 110 comprises at least one processor 111, memory 112, and a user interface 113.

The processor 101 and 111 can be any instruction execution system, apparatus, or device configurable for executing instructions. For example, the processor 101 and 111 might comprise a central processing unit, a graphics processing unit, a controller, a micro-controller, a state machine, or any combination thereof.

The memory 102 and 112 stores content, such as software applications and data, for use by the processor. The memory 102 and 112 can comprise a random-access memory, read-only memory, hard disk, optical, Cloud, decentralized file-sharing network, or any other form of local and/or remote digital storage,. In some aspects, a storage might supplement or replace the memory 102 and 112. The storage might include any number and type of external memories that are accessible to the processor 101 and 111. For example, and without limitation, the storage might include a Secure Digital Card, an external Flash memory, a compact disc, read-only memory, an optical storage device, a magnetic storage device, or any suitable combination of the foregoing.

The user interface 113 can be any device that the processor 111 can configure for receiving user inputs and/or outputting information to the user. One example of user interface 113 comprises a display device configured for displaying an image and/or any other type of visual content. In some aspects, the display device might be a touchscreen that displays visual content and enables the user to interact with the content and provide input to the processor 111. The user interface 113 might receive any number and/or types of design constraints (not shown) and/or any number and/or types of design objectives (not shown) via a GUI. In some aspects, the interface 113 might display any number of solutions of the overall design optimization problem and/or any number of solutions of the constituent optimization problems.

In general, the processors 101 and 111 are configured to implement one or more software applications. For explanatory purposes only, each software application is described as residing in the memory 102 and 112 and executing on the processor 101 and 111 of the corresponding device 100 and 110, respectively. However, in some aspects, the functionality of any number of the disclosed software applications might be distributed across any number of other devices and/or software applications Further, the functionality of any number of software applications might be consolidated into a single software application.

The client memory 112 might store data 119 and computer program instructions, such as a CAD application program 115 and a client-side CAD artificial neural network (ANN) 117. Similarly, the server memory 102 might store data 129 and computer program instructions, such as a CAD server program 125 and a server-side CAD ANN 127.

In some of the disclosed aspects, the CAD application program 115 and/or 125 comprises a structural design application. The structural design application might implement generative design techniques to generate designs for a structural system of a building based on any number and/or type of design objectives and any and/or types of design constraints. As used herein, generative design is a computer-aided design technique and category of software that uses AI to optimize the design process. Generative design software can quickly iterate through many design alternatives and pick the best one according to a set of criteria.

As described herein, a structural design application can define an overall optimization design problem, and then break down the overall optimization design problem into multiple layers of more granular, less complex, optimization problems, referred to herein as constituent optimization problems. Each of the constituent optimization problems might be associated with a different aspect of structural system design problem. To solve the overall optimization design problem, the structural design application can execute a macro-design flow that dynamically self-adjusts based on results generating while solving the constituent optimization problems. In some aspects, the structural design application resides in the memory 102 and/or 112 and executes on the processor(s) 101 and/or 111. In various aspects, the functionality of the structural design application might be distributed across any number of software applications (e.g., 115, 117, 125, and/or 127).

CAD programs 115 and 125 can comprise an application programming interface (API). Similarly, the ANNs 117 and 127 might comprise an API. An API, as used herein, defines how two or more computer programs communicate with each other. It is a software interface that is configured to offer services to other pieces of software. A document or standard that describes how to build or use such a connection or interface is called an API specification. A computer system that meets this standard is said to implement or expose an API. The term API may refer either to the specification or to the implementation.

In some aspects, the client device processor 111 might utilize the client-side CAD application 115 with a CAD API to interface with the server-side CAD application 125. In some aspects, the CAD application program 115 might comprise only a CAD API. This can enable the user to employ the user interface 113 to access the server-side CAD application 125, which may be operable as a Software-as-a-Service (SaaS). The API of the CAD application 125 also enables other software applications to access the server-side CAD application 125. Similarly, APIs of the ANNs 117 and 127 provide access for other software applications. In one aspect, the ANNs 117 and 127 operate together as a distributed AI application. In another aspect, the server-side ANN 127 might gather data 119 from client devices.

The memory (e.g., 112 and/or 102) might comprise sub-applications configured for design, modeling, analysis, optimization, testing, documentation, and manufacturing, etc. The sub-application(s) may implement the various features of the CAD application (115 and/or 125). The sub-application(s) may interact with and/or utilize the ANN (117 and/or 127). The sub-applications might be configured to interact with each other directly or indirectly, such as without having to call external applications.

The CAD application 115 and/or 125 might operate at multiple layers of granulary, such as on components of modules, on the modules themselves, on subassemblies of the modules, and on assemblies comprised of those subassemblies. The objects in each layer of granularity may range from basic building blocks of two-dimensional and three-dimensional shapes to shapes that are themselves made of multiple intricate or detailed shapes (e.g., complex shapes). In addition to shape, each object may include parametric data that, for example, quantify the qualities of the object and how the object reacts to forces and the environment. For example, each object may be associated with a host of parametric data quantifying aspects of the object for purposes of, at least, design, modeling, analysis, optimization, testing, documentation, and manufacturing).

According to some aspects, CAD APIs described herein may be described as an API-first developmental item. In one example, the CAD API may be designed to interface with other applications, including but not limited to: word processing, spreadsheet, circuit simulation, thermal analysis, continuous integration, engineering analysis, computer-aided manufacturing, physical inspection software, robot path planning, enterprise resource planning, manufacturing resource planning, product lifecycle management, and/or supply chain optimization. Other applications might wrap the CAD API described herein into other use cases, such as, but not limited to, program management, financial planning, billing, procurement, and/or systems engineering, etc. By way of example, the CAD server program 125 might comprise instructions for interfacing with a control system (e.g., Computer Numerical Controller 103) of a computer-aided manufacturing machine. In other aspects, the client device 110 might comprise a controller (e.g., 103), and the client-side CAD program 115 might comprise instructions for interfacing with a control system 103.

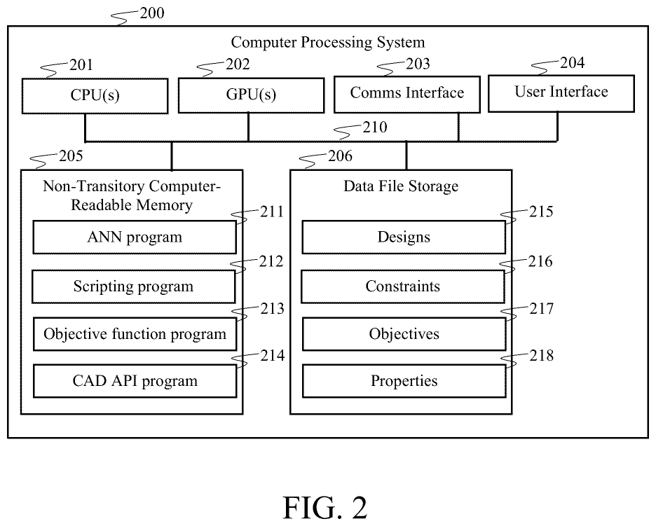

FIG. 2 is a block diagram illustrating an example of a computer processing system 200 configured in accordance with some aspects of the disclosure. The computer processing system 200 might comprise a personal computer, a laptop computer, a tablet computer, a smartphone, a terminal, a server, a computer network, or a similar device or system.

The computer processing system 200 may be implemented with one or more computer processor units (CPUs) 201, graphics processor units (GPUs) 202, communications interface(s) 203, and user interface(s) 204. Memory comprises computer-readable memory 205 for storing programs (e.g., ANN 211, scripting 212, objective function 213, and CAD 214), and data file storage 206 for storing data files (e.g., designs 215, constraints 216, objectives 217, and properties 218). A computer bus 210 communicatively couples together the physical components 201-206.

Examples of computer processors 201 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the computer processing system 200 may be configured to perform one or more of the functions described herein. That is, the CPU(s) 201 and/or GPU(s) 202 may be used to implement any one or more of the processes and procedures described herein.

In one example, the processing system 200 may be implemented with a bus architecture, generally represented by bus 210. Bus 210 may include any number of interconnecting buses and bridges depending on the specific application and design of the processing system 502. The bus 210 links together various circuits, including the one or more processors 201 and 202, and memory 205 and 206. The bus 210 may also link various other circuits, such as timing sources, peripherals, voltage regulators, and power management circuits. The bus 210 may connect with the transceiver/communication interface 203, which may provide a means for communicating with various other apparatuses over a communication network.

The GPU(s) 202 may be coupled to the CPU(s) 201 via the bus 210. The GPU(s) 202 may be designed to accelerate graphics rendering and/or perform or accelerate the performance of other functions. In one example, GPU(s) 202 can be configured for ANN 211 operations. The GPU 210 may include memory (not shown).

The user interface 204 may be configured for a user to input data to, and obtain data from, the system 200. The data may be text, video, audio, or any combination thereof. The user interface 204 may include, for example, a keypad, a display, a touch screen, a speaker, a microphone, one or more switches, one or more control knobs, or any combination thereof. The preceding lists are exemplary and not limiting.

The processors 201 and 202 may be responsible for managing the bus 210 and general processing, including executing software stored on the computer-readable medium 205. When executed by the processors 201 and 202, the software 211-214 may cause the processor 201 and 202 to perform the various functions described herein. The data storage 206 may store data manipulated by the processors 201 and 202 when executing software 211-214. For example, the memory 206 may store variable values, one or more final, and/or one or more intermediate solutions, as well as equations, to be executed commands, and data that is, in general, utilized by the processors 201 and 202 to perform the various functions described herein.

Software 211-214 should be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 205 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 205 may reside in the processing system 200, external to the processing system 200, or distributed across multiple entities, including the processing system 200. The computer-readable medium 205 may be embodied in a computer program product. By way of example, a computer program product may include a computer-readable medium in packaging materials. In some examples, the computer-readable medium 205 may be part of the memory 206.

In some aspects of the disclosure, the processors 201 and 202 may include a communication and processing circuitry/module, configured to communicate with one or more client devices and/or one or more servers. Communication may be accomplished via the transceiver/communication interface 203. In one example, the communication and processing circuitry/module may be configured to communicate with one or more servers via an API, such as the CAD API. In some examples, the communication and processing circuitry/module may include one or more hardware components that provide the physical structure that performs processes related to the disclosed computer aided design. In some implementations, the communication involves receiving information from other devices (e.g., clients and/or servers).

The processing system 200 may further include a computer aided design application programming interface (CAD API) circuitry/module (not shown), configured, for example, as an interface between the user interface 204 and the CAD application 214. According to some aspects, the CAD API circuitry/module might call a local computation that may be handled by the processors 201 and/or 202. In such aspects, preceding the call, the processing system 200 may be configured to determine if the processors 201 and/or 202 and associated memory 206 are sufficient to perform the computation. The computation might be performed using processing and/or memory resources external to the system 200. According to some aspects, the CAD application 214 may reside on a server, and may be accessed via a network. In some aspects, the CAD application may be operated remotely (e.g., CAD API circuitry/module may call a remote computation) by accessing the CAD application via the CAD API.

In some examples, the CAD API circuitry/module may provide a programmatic way to link a physical or a digital design 215 to artificial intelligence 211, automation, etc. For example, an object associated with a file may provide digital manufacturing instructions, or supply chain specifications, or other data relevant to other software elements, intelligence, automation, etc.

In some examples, the CAD API may enable a remote CAD application, such as, for example, a CAD application on a server, to use voxels as an interactive element, and may use constructive solid geometry simulation (CSGS), signed distance functions (SDF), material point method (MPM) and/or other algorithm techniques to allow for solid multi-materials in the design itself. This can improve applications related to 3D printing and non-rigid project constructions, for example.

Using the CAD API, a user may employ scripting 212 A script may, for example, include human readable commands/instructions related to the design/generation of a given object having a given geometry. The script may include information (e.g., machine readable code) that describes the geometry of objects in a way that can be utilized, rendered, manipulated, analyzed, and/or optimized, etc. by a processing system (e.g., the processing system 200). The information/machine code that describes an object may be referred to as “actual object information.”

A scripting language application 212 might be configured to interact with the CAD application 214. In some aspects, the scripting language may include a visual/rendering element. According to some aspects, the scripting language may provide for geometric operations, for example. The scripting language 212 may be configured for provisioning and controlling computer aided manufacturing (CAM) operations. In general, while providing for programmable geometry, the CAD application 214 and associated CAD API may also enable programming of any aspect of CAD and/or CAM, including but not limited to the steps from the formulation of an idea for a project and a product thereof, through specification, analysis, test, planning of a manufacturing process, and manufacturing of the physical product using the manufacturing process.

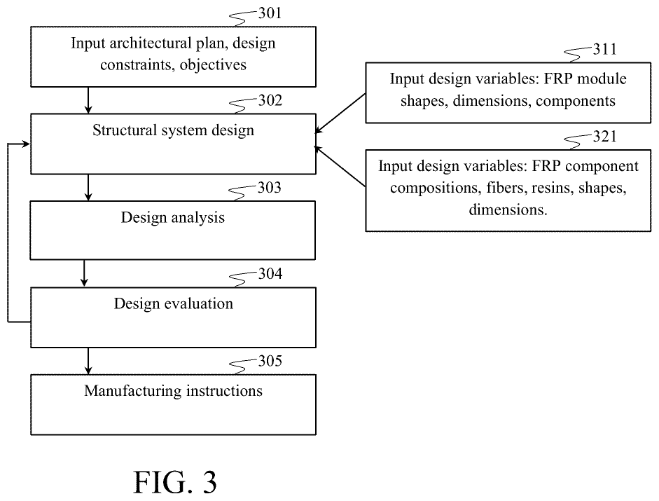

FIG. 3 is a flow diagram that illustrates a method according to one aspect of the disclosure. An architectural plan, design constraints, and design objectives are input 301 to a structural system design process 302. Furthermore, FRP module design variables (e.g., FRP module shapes, dimensions, components) 311 and/or FRP component design variables (e.g., polymer compositions, fibers, component shapes, component dimensions) 321 may be input to the design process 302.

The constraints can specify any amount and/or types of restrictions associated with the building. For instance, the constraints might include, without limitation, any number of design constraints that are specified at a high level by a user input, any number of restrictions derived based on the design constraints and/or any other types of user input, any number and/or types of restrictions associated with the architectural building plan, any number and/or types of restrictions associated with any number and/or types of building codes and/or zoning regulations, and/or any number and/or types of restrictions associated with any aspect(s) of construction.

In some aspects, the structural design application 302 might generate constraints. In some aspects, the user specifies a pre-defined column grid via the GUI or architectural plan, and the structural design application 302 might generate constraints that restrict the locations of columns in accordance to the pre-defined column. In some aspects, the structural design application 302 generates constraints that specify, for example, any number of design safety factors associated with any number and/or type of building codes. Each of the design safety factors might specify, without limitation, a maximum allowable stress (e.g., a shear stress, a bending stress, etc.) for a type of structural member under one or more types of loads. Some examples of design safety factors include bending and vertical deflection safety factors for beams and slabs, shear safety factors for beams and slabs, a vibration safety factor for slabs, and lateral deflection limits on frames. In some aspects, design safety factors can be defined separately for serviceability limit states and ultimate limit states.

The objective function encapsulates any number and/or types of design objectives. Some examples of design objectives include, without limitation, minimizing total weight, minimizing embodied carbon, minimizing material cost, and minimizing material waste. In some aspects, the objective function might include or relate to architectural performance objectives, such as enabling reduced resource consumption (e.g., energy, water, materials, etc.), lower construction costs, lower operational costs, and/or lower maintenance costs.

The structural design application 302 might receive the objective function as a user input and/or might generate the objective function. In some aspect, the objective function quantifies degrees of convergence of designs or any portions thereof with the design objectives. The objective function might be a composite function or an aggregation of metrics that are each associated with one or more of the design objectives. The structural design application 302 attempts to optimize the objective function within the constraints. Thus, the structural design application 302 might incorporate any number and/or type of the constraints into the objective function as penalties. When operable in an ANN, these penalties might be embodied as a cost function in the ANN.

The design variable data might include, without limitation, any amount and/or type of data that defines, at least in part, the design space of the structural system that is associated with a design problem definition. For example, the design variable data might include, without limitation, databases for types of structural members, dimension ranges for the types of structural members, compositions of the structural member types, availability, cost, embodied carbon, or any combination thereof.

Design analysis 303, as described herein, can comprise evaluating trade-offs between performance and objectives relative to structural system design 302 adjustments. This can comprise learning which adjustments result in equitable trade-offs. Evaluation 304 provides for determining if further design changes 302 are likely to yield equitable trade-offs, and controls the iterative process of design 302 and analysis 303 until a structural design is selected. Optionally, the selected design is conveyed to a manufacturing process control 305 that might generate manufacturing and/or assembly instructions for the selected design.

Learning has the advantage that it allows a software agent to initially operate in unknown environments and to become more competent than its initial knowledge alone might allow. The most important distinction is between the “learning element” (e.g., 302), which is responsible for making improvements, and the “performance element” (e.g., 303), which is responsible for selecting external actions. The learning element 302 uses feedback from the “critic” (e.g., 304) on how the agent is doing and determines how the performance element 303, or “actor”, should be modified to do better in the future. The performance element 303 can take in percepts and decides on actions. The learning agent might further comprise a “problem generator”, which might reside in 304 and be responsible for suggesting actions that will lead to new and informative experiences.

It should be appreciated that the process depicted in FIG. 3 might be applied to models of various differing degrees of granularity, such as 1) employed for designing FRP components, which might be used to construct FRP modules (such as frames); 2) employed for designing FRP modules, such as by selecting and assembling FRP components; 3) employed for designing FRP subassemblies, such as by selecting and assembling FRP modules; 4) employed for designing FRP assemblies, such as by selecting and assembling FRP subassemblies; and/or 5) employed for designing building structures, such as by selecting and assembling FRP assemblies.

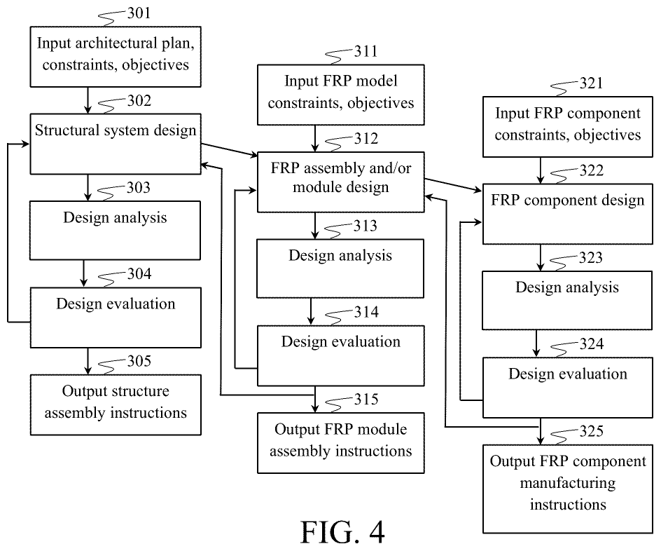

In one aspect, a project request for designing a structural model for an architectural plan instantiates the method of FIG. 4. A CAD application might develop structural model requirements expressed by inputs 301, such as according to parameters provided with the project request. The requirements may be formalized in various documents, drawings, spreadsheets, etc. The system might also create subsystems of requirements (e.g., 311 and 321), which may be developed from the requirements 301. The requirements 301 and subsystems of requirements 311 and/or 321 may be forwarded to a design entity 302.

The design entity 302 may create CAD models and prototype items using a design CAD application. In some instances, the design analyzer 303 may realize that one or more of its designed CAD models and prototype items may be unable to converge, such as due to unrealistic requirements. Accordingly, the analyzer 303 may declare a failure. The design evaluator 304 might analyze the failure, and may return control to the system designer 301, which may select a different configuration of building assemblies, or which may send a project request to an assembly design entity 312 configured to design a new building assembly (i.e., an object at a higher layer of granularity than the structural design). The project request can include assembly and/or module constraints, and possibly, objectives.

The assembly design entity 312 might employ a CAD application to develop assembly model requirements expressed by inputs 311, such as according to parameters provided with the project request from the structural system design entity 302. A similar design analysis 313 and design evaluator 314 might be provided.

In some instances, the design analyzer 313 may realize that one or more of its designed CAD models and prototype items may be unable to converge, such as due to unrealistic requirements. Accordingly, the analyzer 313 may declare a failure. The design evaluator 314 might analyze the failure, and may return control to the assembly designer 312, which may select a different assembly design, or which may send a project request to a module or components design entity 322 configured to design a new module or component (i.e., an object at a higher layer of granularity than the assembly design). The project request can include module or component constraints, and possibly, objectives.

Once the failure is handled, the workflow may be sent back to the previous lower-granularity design entity with a request for review and at least one new lower-granularity design element. The evaluation entity at the previous lower-granularity may review new design element and determine whether the failure can be resolved. Upon resolution of the failure, the corresponding element manufacturing or assembly instructions 315 and/or 325 can be provisioned. This process can cycle through the various workflows to resolve failures. Such failures might be resolved by seeking solutions at one or more higher-granularity scales, as the process breaks down the overall optimization design problem into multiple layers of more granular, less complex, optimization problems (i.e., constituent optimization problems).

In some aspects, one or more of the build/manufacture entities 305, 315, 325 may pass the workflow for the project to a testing entity (not shown), which may utilize a testing CAD application to test the design to verify that the design meets the original or revised requirements. CAD programs can be used in conjunction with manufacturing processes that typically involve the use of CNC machine cutting tools. CAD programs can be used in additive manufacturing, also known as solid free form fabrication or 3D printing, refers to any manufacturing process where 3D objects are built up from raw material (generally powders, liquids, suspensions, or molten solids) in a series of layers or cross-sections. CAD software can be designed to perform automatic generation of 3D geometry (generative design) for one or more parts in a larger system of parts to be manufactured. This automated generation of 3D geometry is often limited to a design space specified by a user of the CAD software, and the 3D geometry generation is typically governed by design objectives and constraints. A design objective function (such as minimizing the waste material or weight of the designed part) can be used to drive the geometry generation process toward better designs. The design constraints can include both structural integrity constraints for individual parts (i.e., a requirement that a part should not fail under the expected structural loading during use of the part) and physical constraints imposed by a larger system (e.g., loading requirements, weight, a requirement that a part not interfere with another part in the system). Further, examples of design constraints include maximum mass, maximum deflection under load, maximum stress, etc. Some CAD software has included tools that facilitate 3D geometry enhancements using lattices and skins of various sizes, thicknesses and densities, where lattices are composed of beams or struts that are connected to each other or directly to solid parts at junctions, and skins are shell structures that overlay or encapsulate the lattices. Such tools allow redesign of a 3D part to be lighter in weight, while still maintaining desired performance characteristics (e.g., stiffness and flexibility). Such software tools have used lattice topologies of various types that can be used to generate lattice structures that can be manufactured.

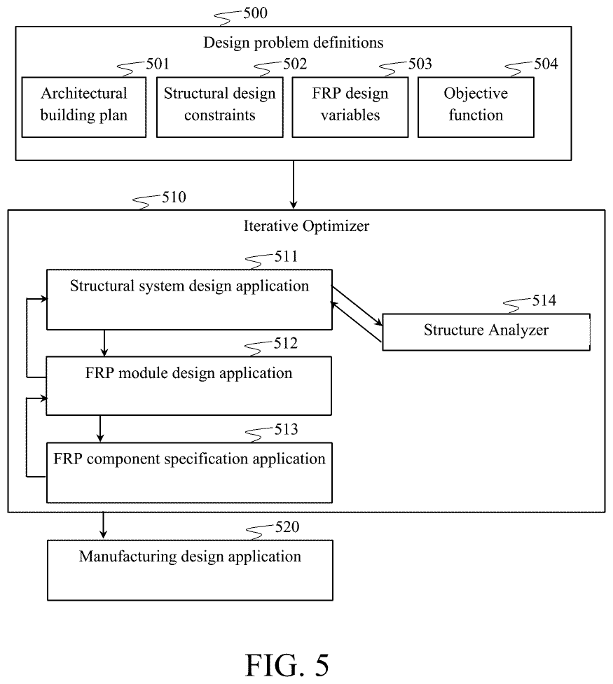

FIG. 5 shows an example of method and apparatus aspects configured to design and manufacture physical structures. An apparatus configured to perform disclosed methods might comprise a computer with at least one processor and at least one memory, and the computer might be connected to a network. The processor can be one or more hardware processors, which can each include multiple processor cores. The memory can include both volatile and non-volatile memory, such as Random Access Memory (RAM) and Flash RAM. The computer can include various types of computer storage media and devices, which can include the memory, to store instructions of programs that run on the processor, including Computer Aided Design (CAD) program(s), which can implement three-dimensional (3D) modeling functions and includes one or more generative design processes for topology optimization using numerical simulation, and including material or microstructure shape optimization techniques, geometrical or macrostructure shape optimization techniques, or both (e.g., using one or more level-set based topology optimization processes).

Design processing definitions 500 might comprise data input and data processing to provide for design problem definitions at one or more scales of granularity. By way of example, but without limitations, the definitions can include an architectural building plan 501, structural design constraints 502, FRP design variables (such as for assemblies, sub-assemblies, modules, components, or combinations thereof) 503, and at least one objective function 504.

The design processing definitions 500 are passed to an iterative optimizer 510, where they are used in a structural system design application 511, an FRP module design application 512, and/or an FRP component specification application 513. A structure analyzer 514 can be configured to analyze the structural system design based on structural design constraints 502 and the objective function 504, such as to optimize the design relative to parameters in the objective function 504 while ensuring the design falls within the constraints 502. In some aspects, the iterative optimizer comprises software instructions residing on at least one non-transitory computer-readable memory, the instructions being configured to operate at least one processor to perform the disclosed methods.

Upon completion of the design optimization, the final design might be transferred to a manufacturing design application, which might configure manufacturing and/or assembly of FRP components, modules, subassemblies, and/or assemblies.

In one disclosed aspect, a method comprises obtaining 500, by a computer aided design program, a design space for a physical structure to be constructed; one or more load cases for the physical structure; and FRP component properties for a plurality of component designs. The method further comprises determining 511, 512, and/or 513, by the computer aided design program, a design space for each of a plurality of modeled objects to be manufactured from which the physical structure will be constructed; one or more design criteria for the modeled object, based at least in part on the one or more load cases; and FRP component selection and arrangement in each of the plurality of modeled objects based on the one or more design criteria. The method further comprises iteratively modifying 510, by the computer aided design program, a generatively designed three dimensional shape of the modeled object in the design space in accordance with the one or more design criteria, the one or more load cases, and the FRP component properties; wherein the iteratively modifying 510 comprises optimizing an objective function 504; and providing, by the computer aided design program, the generatively designed three dimensional shape for use in manufacturing 520 the of the modeled object using one or more computer-controlled manufacturing systems.

Numerical simulations performed by the CAD program(s) can simulate one or more physical properties and can use one or more types of simulation to produce a numerical assessment of physical response (e.g., structural response) of the modelled object. For example, finite element analysis (FEA), including linear static FEA, finite difference method(s), and material point method(s) can be used. Further, the simulation of physical properties performed by the CAD program(s) can include Computational Fluid Dynamics (CFD), Acoustics/Noise Control, thermal conduction, computational injection molding, electric or electro-magnetic flux, and/or material solidification (which is useful for phase changes in molding processes) simulations. Moreover, the CAD program(s) can potentially implement manufacturing control functions.

As used herein, CAD refers to any suitable program used to design physical structures that meet design requirements, regardless of whether or not the CAD program is capable of interfacing with and/or controlling manufacturing equipment. Thus, CAD program(s) can include Computer Aided Engineering (CAE) program(s), Computer Aided Manufacturing (CAM) program(s), etc. The CAD program(s) can run locally on a computer, remotely on a computer of one or more remote computer systems (e.g., one or more third party providers' one or more server systems accessible by the computer via a network) or both locally and remotely. Thus, a CAD program can be two or more programs that operate cooperatively on two or more separate computer processors in that one or more programs operating locally at computer can offload processing operations (e.g., generative design and/or numerical simulation operations) “to the cloud” by having one or more programs on one or more computers perform the offloaded processing operations.

The CAD program(s) can present a user interface (UI) on a display device of the computer, which can be operated using one or more input devices of the computer (e.g., keyboard and mouse). The display device and/or input devices can also be integrated with each other and/or with the computer, such as in a tablet computer (e.g., a touch screen can be an input/output device). Moreover, the computer can include or be part of a virtual reality (VR) and/or augmented reality (AR) system. For example, input/output devices can include a VR/AR input glove and/or a VR/AR headset. In any case, a user and/or an ANN interacts with the CAD program(s) to create and modify 3D model(s), which can be stored in 3D model documents.

Examples described herein include various systems, devices, methods, and servers including but not limited to a system implementing a computer aided design application and an associated computer aided design application programming interface and scripting language, a client device implementing a computer aided design application programming interface and scripting language both associated with a computer aided design application, a first method, operational at a client device, implementing a computer aided design application programming interface and scripting language both associated with a computer aided design application, a server implementing computer aided design application and an associated computer aided design application programming interface and scripting language, and a second method, operational at a server, implementing a computer aided design application and an associated computer aided design application programming interface and scripting language.

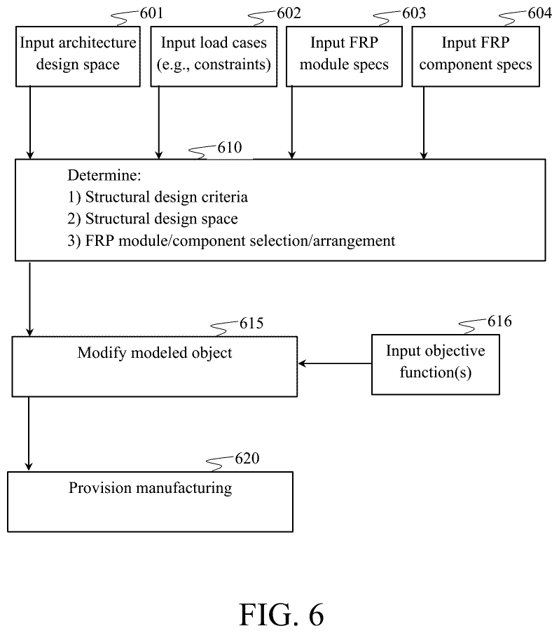

FIG. 6 illustrates disclosed aspects that can be embodied by various systems, devices, methods, and servers. Inputs (architectural design space 601, constraints 602, FRP module specifications 603 and FRP component specifications 604) are retrieved, selected, and/or computer, and then provided to a design element 610, which can determine structural design criteria, a structural design space, and FRP module and/or component provisioning and/or design. A modification element 615 might receive or determine one or more objective functions to be used in modifying design features of the structure and possibly, some of its components. Upon determining a satisfactory design result, a manufacturing element 620 employs the design to provision manufacturing and/or assembly.

An FRP manufacturing system might fabricate components from a three-dimensional (3D) CAD model. FRP manufacturing 620 might employ process-control systems for pultrusion, extrusion, additive layer manufacturing, fused deposition modelling, 3D printing, etc. Mechanical, physical, and thermal properties of fiber reinforced thermoplastic composite materials are affected by manufacturing parameters controlled by the manufacturing element 620 (e.g., production speed, temperature, building principle, etc.), and constitutive materials properties, (e.g., polymeric matrices, reinforcements, and additional materials). The reinforcement fibers can be categorized based on available types (e.g., carbon, glass, aramid, etc.), fiber size (e.g., length, thickness), and fiber architectures (density, pattern, orientation). Various types of fillers can be blended into the polymeric matrix to improve mechanical and thermal properties. Mechanical properties can include stiffness and strength (e.g., tensile, flexural, compression, shear), impact resistance, surface hardness, and fracture mechanics. Pultrusion manufacturing parameters can include feed rate, guide tension, dye temperature, concentration of resin additives, performer additives, fiber volume fraction.

In some aspects, an ANN methodology can be particularly useful for approximating relationships between variables when there is a large number of inputs, and the relationships between the variables are nonlinear. This is certainly the case for a architectural CAD system, which will have a large number of input parameters and a large number of output possibilities, and the relationships between them can be highly non-linear. A Machine Learning module (such as an ANN) can use some machine learning method(s) to find a relationship between inputs, outputs, design goals, and current and previous structural designs (and their corresponding simulation data) in order to propose changes to the current structural design that will allow the structure to better meet or exceed design goals.

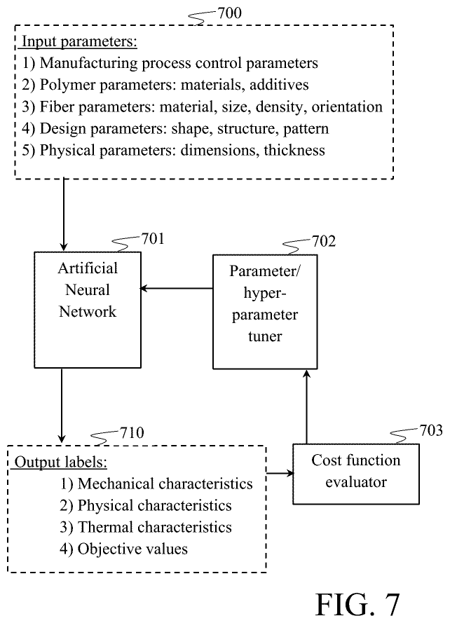

FIGS. 7-9 each illustrates an ANN that might be configured to operate together or separately, in coordination with a CAD system, or independent of a CAD system. Training a deep learning neural network to manufacture an FRP structural member, an FRP module constructed from selected FRP structural members, assemblies (or subassemblies) constructed from selected FRP modules, and/or a structural building system comprising selected assemblies having specific mechanical, physical, and thermal characteristics involves a complex process that requires a large amount of data and an appropriate neural network architecture. This can comprise the following features.

With respect to FIG. 7, an ANN 701 is configured to learn FRP component design inputs that result in particular performance metrics (outputs). In this example, the ANN 701 might be configured learn which design and/or manufacturing aspects enable an item of manufacture to meet particular mechanical, physical, thermal, and objective-value requirements. Training can involve a process known as neural network-based generative design. The primary goal is to have the neural network learn to generate designs that meet the desired requirements. The steps involved might include one or more of the following:

Data Collection: To train the neural network, a dataset of FRP component designs and/or manufacturing techniques can be provisioned 700. This dataset might consist of various designs, each labeled with their corresponding mechanical, physical, thermal, objective-value features and/or other performance metrics 710. The dataset 700, 710 may be obtained from previous designs, simulations, or physical prototypes.

Data Preprocessing: The collected data may need to be preprocessed to ensure it is in a suitable format for training the neural network. This step may involve normalization, feature scaling, or other techniques to ensure the data is on a comparable scale.

Feature Representation: Each design in the dataset can be represented in a format that the neural network can process. This may involve using techniques like CAD representations, voxel-based representations, or image-based representations.

CAD representations, as disclosed herein, can be used by the ANN to create, analyze, modify, and optimize mechanical and physical designs before physically implementing the designs. The designs may be based on compilations of modeled objects (e.g., goods and materials) comprised of one or more component parts, subassemblies, and assemblies. One or more mathematical formulae may mathematically represent each modeled object. The formulae account for myriads of variables that together define the modeled object. For example, an FRP beam model may specify its shape (e.g., I-beam, T-beam), width, length, height, thermal conductivity, hardness, tensile strength, elongation, fatigue strength, corrosion plasticity, melting point, etc.

Neural Network Architecture: This involves provisioning an appropriate deep learning neural network architecture 701 suitable for generative design tasks. Exemplary choices include variational autoencoders (VAEs), generative adversarial networks (GANs), and deep recurrent neural networks (RNNs). These architectures are capable of generating new designs based on learned patterns from the training data.

Loss (or cost) Function: This defines a suitable loss function that quantifies the similarity between the generated design and the target features. The loss function guides 703 the network to generate designs that meet the specific requirements.

Training: Training 702 the neural network employs the labeled dataset. During training 702, the network learns to map the input features to the corresponding design space, capturing the patterns and relationships between input parameters and output features. This comprises tuning 702 ANN parameters and hyperparameters to enable the ANN to operate more efficiently, thereby achieving its design objectives faster.

Generation and Optimization: After the network is trained 702, it can be used to generate new designs based on specific input parameters. For example, given a set of desired features, the network can produce design proposals that should meet those requirements. The generated designs may not be perfect at first, but can serve as starting points for further optimization. The neural network may require hyperparameter tuning and architecture adjustments to achieve the desired level of accuracy and generalization.

Iterative Optimization: Depending on the complexity of the design task and the required precision of the mechanical features, an iterative optimization process may be needed. The initial designs generated by the network can be further refined and optimized using traditional engineering optimization methods or computational tools, considering additional constraints and manufacturing considerations.

Validation: The generated designs can be validated by testing their performance against the desired features. This may involve simulation, prototyping, and/or physical testing.

Fine-tuning: If necessary, fine-tuning the neural network can be accomplished by using additional data or updated requirements to improve its performance.

Deployment: Once the neural network has been trained and validated, it can be deployed to assist in the design and manufacturing of FRP structural members, predicting the required manufacturing parameters to achieve specific characteristics.

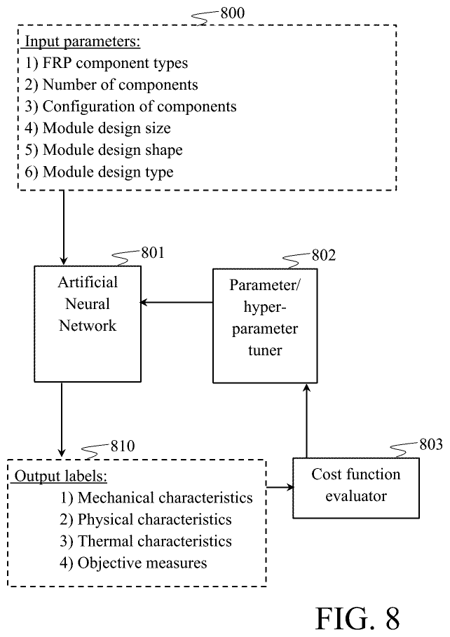

With respect to FIG. 8, an ANN 801 is configured to learn FRP module design inputs that result in particular performance metrics (outputs). In this example, the ANN 801 might be configured learn which design and/or assembly techniques enable an FRP module (e.g., a frame assembly) constructed from selected FRP components to meet particular mechanical, physical, thermal, and/or objective-value requirements. Training a neural network to design building structure modules that meet specific physical and mechanical constraints while optimizing a particular objective, such as minimizing cost, involves a combination of generative design and optimization techniques. The steps involved might include one or more of the following:

Data Collection: This involves gathering a dataset of building structure modules, each labeled 810 with their physical properties, mechanical constraints, and associated costs. The dataset may include existing designs, simulations, or real-world examples, and might include input categories 800, such as FRP component types, number of components, configuration of components, module size, module shape, and/or module design type.

Feature Representation: Represents each building structure module in a format suitable for the neural network. This could be in the form of architectural drawings, 3D models, or any other representation that captures necessary design information.

Neural Network Architecture: Provisions an appropriate neural network architecture suitable for generative design tasks. Variational autoencoders (VAEs) and generative adversarial networks (GANs) are commonly used for such tasks. The network should be capable of generating new building structure modules based on the learned patterns from the training data.

Loss (or Cost) Function: Defines 803 a loss function that incorporates the physical and mechanical constraints as well as the cost objective. The loss function should encourage the network to generate designs that meet the specified constraints and minimize the cost.

Training: Training 802 the neural network uses the labeled dataset 800, 810. During training 802, the network learns to map the input features (e.g., physical and mechanical properties) to the corresponding building structure modules, capturing the relationships between input parameters and design outcomes. Learning is achieved by tuning 802 ANN parameters and hyperparameters to minimize the loss function 803.

Generation and Optimization: After the network is trained, it can be used to generate new building structure module designs based on specific input parameters (e.g., required load-bearing capacity, weight, materials, etc.). However, the initial designs generated by the network may not be optimal in terms of cost.

Optimization Process: Optimization algorithms refine the generated designs and find the optimal solutions that meet the constraints and minimize the cost. This can involve gradient-based optimization techniques, evolutionary algorithms, or other optimization methods.

Evaluation and Validation: Evaluates the generated designs and optimized solutions against the specified physical and mechanical constraints. Validating the results can be done via simulations, structural analysis, and/or physical testing to ensure the designs are safe and feasible.

Fine-tuning: If necessary, the neural network can be fine-tuned using additional data or updated requirements to improve its performance and ability to generate better initial designs.

Iterative Process: The entire process might be iterative, where the neural network generates designs and optimization algorithms, refines them, and uses feedback from the evaluation process to improve both the neural network and the optimization process.

The ANN serves as an assistive tool, helping to explore and generate potential design solutions, assisting architects and engineers in defining design constraints, interpreting results, and making informed decisions regarding structural integrity, safety, and other important aspects of building design.

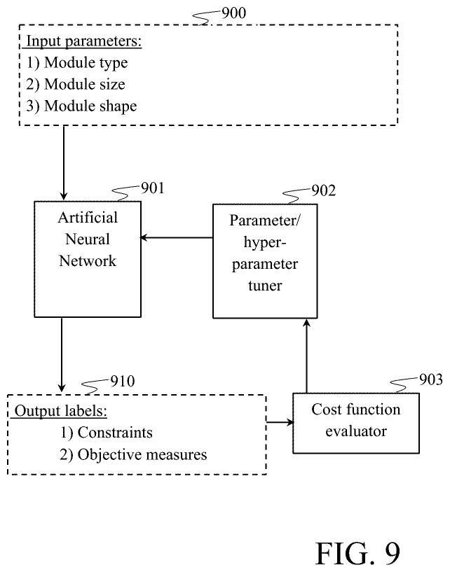

With respect to FIG. 9, an ANN 901 is configured to learn FRP building structure design inputs that result in particular performance metrics (outputs). In this example, the ANN 901 might be configured learn which FRP modules and/or assembly techniques enable an FRP building structure to meet particular mechanical, physical, thermal, and/or objective-value requirements. Training a neural network to design building structures that meet specific physical and mechanical constraints while optimizing a particular objective, such as minimizing cost, involves a combination of generative design and optimization techniques. The steps involved might include one or more of the following:

Data Collection: Gathers a dataset of building structure designs, including information 900 about the selected building modules, their physical properties, mechanical constraints, and associated costs. This dataset may come from existing designs, simulations, or real-world examples.

Building Module Representation: Represents each building module in a format suitable for the neural network. This representation should capture the necessary design information, such as architectural drawings, 3D models, or other relevant data.

Neural Network Architecture: Provisions a suitable neural network architecture that combines generative capabilities with reinforcement learning components. Recurrent neural networks (RNNs), transformer-based models, or graph neural networks (GNNs) can be used to handle the nature of building designs.

Training Setup: Sets up the training process to optimize the neural network's parameters. This involves defining the reward function that guides the reinforcement learning aspect of the training. The reward function should incentivize designs that meet physical and mechanical constraints while minimizing the cost.

Reinforcement Learning: Trains 902 the neural network using reinforcement learning techniques. During training 902, the neural network generates building structure designs incrementally, one building module at a time. After generating each module, the design is evaluated against the physical and mechanical constraints and the cost objective.

Reward Function: The reward function helps guide 903 the learning process. It assigns a score to each generated design based on how well it meets the constraints and the cost optimization objective. The neural network uses these rewards to adjust its parameters and improve the quality of the generated designs. The reward function encapsulates the goals an agent is driven to act on. This function can also encapsulate acceptable trade-offs between accomplishing conflicting goals. Goals can be explicitly defined or induced. If the AI is programmed for reinforcement learning, it employs a reward function that encourages some types of behavior and punishes others. Alternatively, an evolutionary system can induce goals by using a fitness function to mutate and preferentially replicate high-scoring AI systems.

Optimization: As the neural network generates building structures, an optimization algorithm, such as genetic algorithms or evolutionary strategies, can be employed to refine the design further. The optimization process searches for combinations of modules that better meet the specified constraints and minimize the cost.

Evaluation and Validation: Evaluates the generated building structures against the physical and mechanical constraints and validates the results through simulations and structural analysis to ensure the designs are safe, feasible, and comply with regulations and standards.

Fine-tuning: Fine-tunes the neural network using additional data or updated requirements to improve its performance and ability to generate optimal building structures.

Iterative Process: The entire process might be iterative, where the neural network generates designs, the optimization process refines them, and feedback from the evaluation process is used to improve both the neural network and the optimization process. The success of training such a neural network depends on the availability of high-quality data, appropriate preprocessing, and careful selection of the neural network architecture and hyperparameters.

While component objects may be created and analyzed individually, it may be advantageous for CAD systems to combine the component objects to form subassemblies and assemblies (e.g., modules) to obtain the full benefit of using a CAD system. Therefore, CAD systems may have an ability to model the subassemblies, to account for interactions between component objects, and may have an ability to model assemblies, to account for interactions between subassemblies as well as interactions between modeled objects.

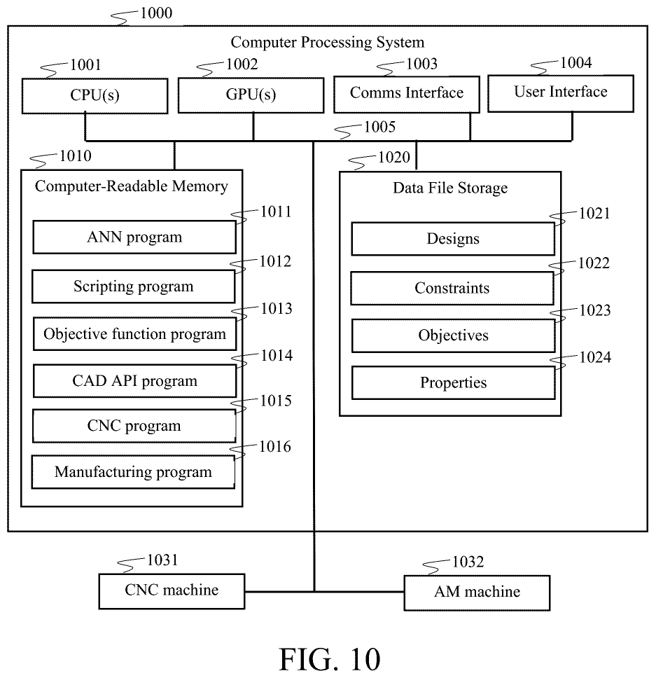

FIG. 10 is a schematic representation of a computer processing environment 1000 in which CAD systems may be configured according to some aspects of the disclosure. A CAD system may be embodied in a device having a data input device 1003, a data output device 1003, working memory 1010, storage memory 1020, and one or more processors 1001 and 1002 coupled to the data input device 1003, the data output device 1003, user interface 1004, the working memory 1010, and the storage memory 1020 via a bus 1005. Optionally, the computer processing environment 1000 might be communicatively coupled to a CNC machine 1031 and/or an AM machine 1032.

Examples of such computer processing environments 1000 include a personal computer, a laptop computer, a tablet computer, a server, a Cloud computing architecture, a decentralized computing architecture, a distributed computing architecture, and a virtual computing architecture. The preceding list is exemplary and not limiting. Before utilizing a CAD system, the computer processing environments 1000 might download an entire application (e.g., a software suite comprised of multiple software modules, predefined object models, etc.) or might operate one or more parts of the application remotely, such as on one or more remote servers accessible via the communication interface 1003. Applications might include an ANN 1011, a scripting program 1012, an objective-function program 1013, a CAD program 1014, a CNC program, and/or a manufacturing control program 1016.

In disclosed aspects, the computer processing environment 1000 might employ software-as-a-service, Cloud computing services, Cloud storage, and the like. Accordingly, computing resources 1001 and 1002, memory 1010, and/or storage 1020 might reside on other machines. Disclosed aspects may employ a client-server architecture that is configurable with respect to software applications 1011-1016, notably the ANN 1011 and CAD 1014 applications. In such aspects, data (e.g., 1021-1024) might be shared across different computer processing environments. As ANNs typically require very large data sets and benefit from expansive computational resources, disclosed aspects can be provisioned in a Cloud environment to collect the large amount of CAD and ANN data generated by users, and possibly coordinate Cloud processing resources to develop and refine AI models.

In some aspects, designs, constraints, objectives, and/or properties developed by client-side CAD use can be gathered into large data sets. These data sets can be used for training server-side and/or Cloud-based ANNs. Parameters learned by these ANNs might be distributed to client-side ANNs for design tasks, or the design tasks might be performed by the server-side and/or Cloud-based ANNs.

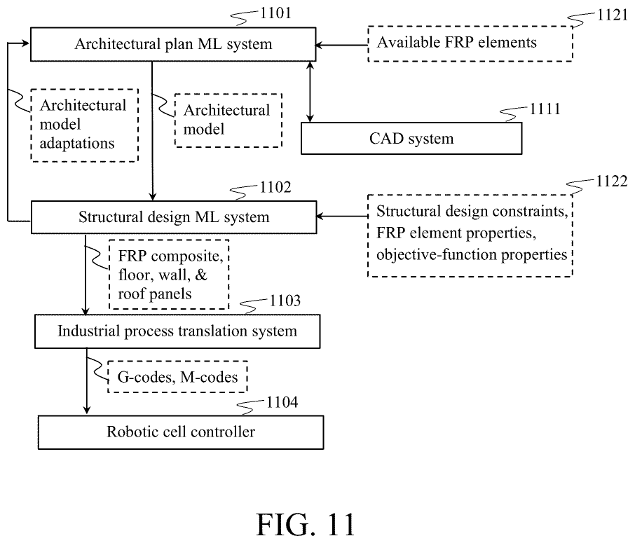

FIG. 11 illustrates a method and apparatus that are configured in accordance with disclosed aspects. An architectural plan ML system (such as one or more computer processors configured to run an ANN) 1101 is communicatively coupled to a CAD system 1111 and a structural design ML system (such as one or more computer processors configured to run an ANN) 1102. The structural design ML system 1102 comprises or is communicatively coupled to an industrial process translation system 1103. The industrial process translation system 1103 might be communicatively coupled to a robotic cell controller 1104. The CAD system 1111 comprises a user interface (not shown) that can enable the user to interact with (e.g., display and change) architectural and structural models. In some instances, a single ML system might implement the architectural modeling 1101 and structural design 1102 aspects.

In one functional aspect, architectural plan ANN 1101 is provided with available design-element inputs and/or structural-element inputs 1121 that it can use to develop an architectural plan. The CAD system 1111 can also provide inputs, including data files and user inputs, to direct the architectural plan ANN 1101. The architectural plan, embodied in an architectural model generated and/or adapted by system 1101, might be adapted in real time by both the user inputs and the structural design ML system 1102.

In one example, structural design constraints, FRP component properties, and/or objective function properties 1122 are input to the structural design ML system 1102, which can adapt the architectural model to comply with structural design constraints, and possibly, to optimize at least one objective function, such as minimizing overall cost of construction. The architectural model adaptations might be returned to the architectural plan ANN 1101, and displayed to the user via the CAD system 1111. The user might interact with the architectural model (via the CAD system 1111), such as to select or adapt architectural design criteria, which the architectural plan ANN 1101 might use to adapt the architectural model via collaborative interactions with the structural design ML system 1102. The operations performed by the architectural plan ANN 1101 and the structural design ML system 1102 can comprise an iterative process whereby the architectural design criteria guides the structural design, and (optionally) whereby the structural design constraints might require the structural design ML system 1102 to modify the architectural design criteria.

In some instances, the structural design ML system 1102 is configured to modify the architectural design criteria (and thus, the architectural model) to achieve a predetermined objective function. In such instances, the user and/or the architectural plan ML system 1101 might determine which architectural model adaptations are acceptable. The architectural plan ML system 1101 might provide multiple candidate architectural models to the CAD system 1111 for the user to evaluate. The multiple candidate architectural models might be provided in accordance with a range of features (e.g., architectural design criteria and objective function criteria) specified by the CAD system 1111 or the user.

In one example, the architectural plan ML system 1101 generates the architectural model by selecting and arranging components from the available FRP elements 1121. The structural design ML system 1102 might adapt the selection and/or arrangement of the FRP components in the architectural model (in accordance with FRP component properties) such that the adapted model at least complies with the structural design constraints, and optionally, optimizes at least one objective function.

In some examples, the structural design ML system 1102 might interact with the user via the CAD system 1111, either directly, or through the architectural plan ML system 1101. For example, as the user employs the CAD system 1111 to draft an architectural plan, the structural design ML system 1102 might filter a graphical representation of available FRP elements that the user can select, or suggest particular elements or various design adaptations, such as to comply with structural design constraints as they apply to the architectural model.

The structural design ML system 1102 can output a specification comprising FRP elements and/or FRP models. By way of example, but without limitation, the structural design ML system 1102 outputs specifications for FRP frame assemblies or FRP composite floor, wall, and roof panels. The specifications can be communicated to the industrial process translation system 1103. Such specifications might also be conveyed to the CAD system 1111.

The industrial process translation system 1103 is responsive to the specifications for provisioning (e.g., selecting and/or writing) computer code for controlling manufacturing and/or assembly machinery, such as the robotic cell controller 1104 or some other computer-aided manufacturing controller. In one instance, the industrial process translation system 1103 provisions computer-aided manufacturing software to optimize tooling paths and generate G-code (or some other preparatory codes) for CNC machining (e.g., CNC milling, CNC lathe, 3D printer, and/or some other computer-controlled machine tool). The industrial process translation system 1103 might provision M-code, which is another machine control language for CNC machining used with G-code to switch various machine functions off and on. For example, G-code activates the CNC machine, and M-code activates the machine's programmable logic controller.

Also known as a work cell, a robotic cell is a closed workspace where one or more robots are installed. Robotic cells contain systems that enable a robot, or multiple robots, to perform tasks on an assembly line. These tools may include sensors, end effectors, tooling, part feeding mechanisms, safeguards, and others. Instead of distributing manufacturing steps across multiple stations, a robotic cell can perform the entirety of a manufacturing process in the cell. Assembly robotic cells manipulate components into a specific position or into an assembly for future packaging, shipping, or use.

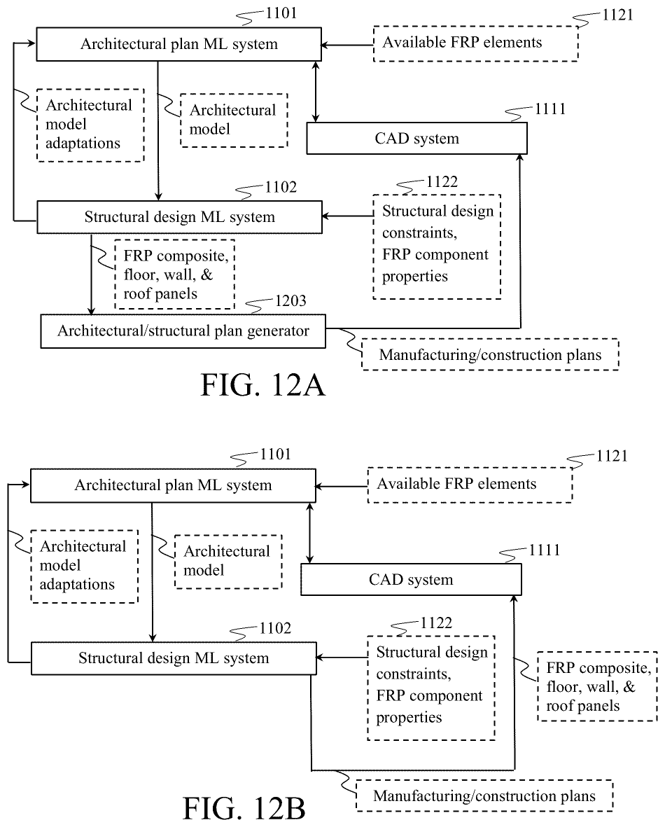

FIG. 12A illustrates a method and apparatus configured in accordance with various disclosed aspects. The structural design ML system 1102 outputs specifications for FRP frame assemblies or FRP composite floor, wall, and roof panels to an architectural/structural plan generator 1203. In some instances, the architectural/structural plan generator 1203 is embodied in either or both systems 1101 and 1102. Using the specifications output by the structural design ML system 1102, the architectural/structural plan generator 1203 generates manufacturing and/or construction plans (e.g., specifications and/or instructions), which can be communicated to the CAD system 1111 for output and to be displayed to the user.

FIG. 12B illustrates a method and apparatus configured in accordance with various disclosed aspects. The structural design ML system 1102 communicates specifications for FRP frame assemblies or FRP composite floor, wall, and roof panels to the CAD system 1111. The structural design ML system 1102 might communicate manufacturing and/or construction plans to the CAD system 1111. In some instances, the CAD system 1111 comprises an interactive user interface to enable a user to interact with the specification and/or plans. By way of example, an interactive user interface can comprise a graphical user interface configured to display the specification and/or plans, and at least one user control that permits the user to interact with elements displayed in the graphical user interface. This might allow the user to delete, add, modify, reshape displayed elements (e.g., FRP components, models, subassemblies, and/or assemblies) in the specification and/or plans.

By way of example, but without limitation, blocks depicted in each figure herein might be interpreted as apparatus components of electronic circuitry; programmatic elements in software residing on a non-transitory computer-readable memory; functional elements of circuitry, or firmware and/or software stored in non-transitory memory (or any combination thereof) that cause at least one computer processor and/or programmable circuitry to perform corresponding functions described herein; steps of a method performed by circuitry, at least one computer processor, device, network, or system; or steps of a method that combines, manufactures, assembles (or causes the assembly of) the blocks to produce an apparatus, program at least one computer processor, configure programmable circuitry, manufacture circuitry, or cause software instructions embodying the steps of the method to be stored on a non-transitory computer-readable medium.

In one example, “providing for”, “provisioning”, or “configuring” describes producing, manufacturing, and/or assembling blocks to manufacture an ASIC, an FPGA, an article of manufacture (such as a non-transitory computer-readable memory), a circuit, a computer system, a computer network, a computer-controlled machine. In another example, “providing for”, “provisioning”, or “configuring” describes producing, manufacturing, and/or assembling functional blocks to make a CAD, a CAM, a CNC machine, a robotic cell, and/or an ANN. In another example, “providing for”, “provisioning”, or “configuring” describes producing, manufacturing, and/or assembling hardware, firmware, software, and/or a virtual machine. In another example, “providing for”, “provisioning”, or “configuring” describes producing, manufacturing, and/or assembling corresponding functional components configured to operate in a CAD, a CAM, a CNC machine, a robotic cell, an ANN, or any combination thereof.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, an FPGA, a CPU, a GPU, or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. As used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C). As used herein, including in the claims, “and” as used in a list of items prefaced by “at least one of” indicates a disjunctive list. For example, “at least one of A, B, and C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An apparatus, comprising:
an architectural plan machine-learning system configured to generate an architectural model;
a structural design machine-learning system communicatively coupled to the architectural plan machine-learning system and configured to adapt the architectural model to satisfy structural design constraints and optimize at least one objective function, the structural design machine-learning system being further configured to select structural components for use in the architectural model; and
an industrial process translation system communicatively coupled to at least one of the structural design machine-learning system and the architectural plan machine-learning system, and configured to generate manufacturing instructions or assembly instructions for use by at least one computer-controlled machine to manufacture or assemble the structural components.

2. The apparatus of claim 1, wherein the industrial process translation system is communicatively coupled to the at least one computer-controlled machine.

3. The apparatus of claim 1, wherein the structural design machine-learning system satisfies the structural design constraints by selecting fiber-reinforced polymer (FRP) elements to include in the architectural model.

4. The apparatus of claim 3, wherein selecting is based on FRP element properties.

5. The apparatus of claim 1, wherein the structural design machine-learning system satisfies the structural design constraints by selecting FRP design parameters and generating the manufacturing instructions based on the FRP design parameters, the FRP design parameters comprising at least one of dimensions, shape, and FRP composition.

6. The apparatus of claim 1, wherein the industrial process translation system is configured to cause the at least one computer-controlled machine to manufacture or assemble the structural components.

7. The apparatus of claim 1, wherein machine learning comprises employing an artificial neural network.

8. An apparatus, comprising:
an architectural plan machine-learning system configured to generate an architectural model;
a structural design machine-learning system communicatively coupled to the architectural plan machine-learning system and configured to adapt the architectural model to satisfy structural design constraints and optimize at least one objective function; and
a computer-aided design (CAD) system communicatively coupled to at least one of the structural design machine-learning system and the architectural plan machine-learning system, the CAD system being configured to provide an interactive display of manufacturing plans or construction plans produced by the structural design machine-learning system, the interactive display enabling a user to add, delete, and/or modify structural components in the manufacturing or construction plans.

9. The apparatus of claim 8, wherein the structural design machine-learning system satisfies the structural design constraints by selecting fiber-reinforced polymer (FRP) elements to include in the architectural model.

10. The apparatus of claim 9, wherein selecting is based on FRP element properties.

11. The apparatus of claim 8, wherein the structural design machine-learning system satisfies the structural design constraints by selecting FRP design parameters and generating the manufacturing plans based on the FRP design parameters, the FRP design parameters comprising at least one of dimensions, shape, and FRP composition.

12. The apparatus of claim 8, wherein the CAD system is configured to be communicatively coupled to an industrial process translation system, the industrial process translation system configured to generate manufacturing instructions or assembly instructions for use by at least one computer-controlled machine to manufacture or assemble the structural components.

13. The apparatus of claim 8, wherein machine learning comprises employing an artificial neural network.

14. A method, comprising:
employing machine learning to generate an architectural model;
employing machine learning to adapt the architectural model to satisfy structural design constraints and optimize at least one objective function;
employing machine learning to select structural components for use in the architectural model; and
generating manufacturing instructions or assembly instructions for use by at least one computer-controlled machine to manufacture or assemble the structural components.

15. The method of claim 14, further comprising at least one of manufacturing or assembling the structural components.

16. The method of claim 14, wherein employing machine learning to adapt the architectural model comprises selecting fiber-reinforced polymer (FRP) elements to include in the architectural model.

17. The method of claim 16, wherein selecting is configured based on FRP element properties.

18. The method of claim 14, wherein employing machine learning to select structural components comprises selecting FRP design parameters and generating the manufacturing instructions based on the FRP design parameters, the FRP design parameters comprising at least one of dimensions, shape, and FRP composition.

19. The method of claim 14, wherein the manufacturing instructions or assembly instructions are communicatively coupled to at least one computer-controlled machine to manufacture or assemble the structural components.

20. The apparatus of claim 14, wherein machine learning comprises employing an artificial neural network.
